(19) United States
(12) Patent Application Publication
(10) Pub. No.: US 2014/0082426 A1
(43) Pub. Date: Mar. 20, 2014

(54) DETECTION CIRCUIT FOR FLEXIBLE PRINTED CIRCUIT CONNECTION INTEGRITY

(71) Applicants: Yang Yueng Melvin Yap, Singapore City (SG); Scott Miles, Belgium, WI (US); Chiu-Ju Teng, New Taipai City (TW); Chih Wei Chang, Bade City (TW); Chingchi Yang, Gueishan Township (TW)

(72) Inventors: Yang Yueng Melvin Yap, Singapore City (SG); Scott Miles, Belgium, WI (US); Chiu-Ju Teng, New Taipai City (TW); Chih Wei Chang, Bade City (TW); Chingchi Yang, Gueishan Township (TW)

(73) Assignees: Delta Electronics, Inc., Taoyuan City (TW); Rockwell Automation Asia Pacific Business Ctr. Pte., Ltd., Singapore (SG)

(21) Appl. No.: 13/778,589

(22) Filed: Feb. 27, 2013

(30) Foreign Application Priority Data
Sep. 20, 2012 (SG) 201207000-9

(51) Int. Cl. G06F 11/26

(52) U.S. Cl. CPC G06F 11/26
USPC 714/44

(57) ABSTRACT

Provided is a connection detector assembly for detecting a connected state between a keypad and a processor along a flexible circuit. The assembly comprises a keypad with a plurality of buttons, each button including button contacts. A flexible printed circuit having a plurality of electrical traces aligned along a width of the flexible printed circuit and includes a set of two or more button signal traces individually electrically coupled with a first button contact of a corresponding one of the plurality of buttons. A first diagnostic electrical trace and a second diagnostic electrical trace form a diagnostic circuit with one another. A receiving unit receives the flexible printed circuit. A processor electrically couples to the diagnostic electrical circuit performs a diagnostic check of the diagnostic circuit to determine a connected state, the connected state indicating whether or not a failure condition exists along a designated portion of the diagnostic circuit.

### CROSS-REFERENCE TO RELATED APPLICATIONS

This application claims priority to and the benefit of Singapore Patent Application No. SG 201207000-9, filed Sep. 20, 2012, the entirety of which is hereby incorporated by reference as if fully set forth herein.

### FIELD OF THE INVENTION

The present disclosure relates generally to the field of device connections and more specifically to an assembly for detecting a connection integrity between an electric device and a receiving unit device. This disclosure is particularly related to connection detection of a flexible printed circuit extending from a keypad membrane that is inserted into a printed circuit board connector.

### BACKGROUND

Conventionally, peripheral electronic devices communicate with computing systems by various types of electrical power and data transfer elements such as cables, wires, buses, traces, slots, etc. In a system such as a motor controller, a peripheral electronic device such as a keypad membrane is electrically connected to a printed circuit board of the motor controller to transfer signals between the keypad and the controller. In this instance, the electrical signals can be transferred over a data transfer element such as a flexible printed circuit between the motor controller and the keypad. The flexible printed circuit can include a plurality of electrical traces that can be connected to the printed circuit board associated with the motor controller. To facilitate a proper connection with the motor controller, the electrical traces maintain sufficient contact with corresponding electrical pins disposed on the printed circuit board that are adapted to electrically communicate with the controller.

Many known connection types incorporate mechanical fasteners along with other structural members to rigidly support and maintain sufficient contact between the electrical traces and the electrical pins. Descriptions of connection detector applications are found in U.S. Pat. No. 8,112,568 by Ely et al., U.S. Pat. No. 7,391,334 by Miyake et al., U.S. Pat. No. 6,149,464 to DeBauche et al., and U.S. Pat. No. 6,368,155 by Bassler et al., which are incorporated herein by reference. These disclosures each require a specialized feature such as a mechanical fastener, a complex electrical connection and/or an advanced circuit configuration to facilitate the detection of each device connection status. However, these specialized features may be inflexible, take up too much space and/or require additional costs that are undesirable. Additionally, they may not be able to detect if a connection has failed or has become disconnected during the product lifetime. In a membrane keypad application, these designs will not allow a user to know if the keypad buttons are working until it is pressed and found to be non-responsive.

Therefore, there is a need to provide a connection detector assembly and method that is configured to detect connection integrity between a peripheral electric device such as a membrane keypad and a receiving unit for electrical communication therebetween that reduces reliance on rigid structural members and also avoids the additional costs incurred through the use of specialized features.

### SUMMARY

One or more aspects of the disclosure are now summarized to facilitate a basic understanding of the disclosure, wherein this summary is not an extensive overview of the disclosure, and is intended neither to identify certain elements of the disclosure, nor to delineate the scope thereof. The primary purpose of the summary, rather, is to present some concepts of the disclosure in a simplified form prior to the more detailed description that is presented hereinafter. The present disclosure relates to improvements in connection detection assemblies for identifying a connection integrity or state of an electronic device and a receiving unit on a printed circuit board.

In accordance with one or more aspects of the disclosure, a connection detector assembly for detecting a connected state between a keypad and a processor is provided. The assembly comprises a keypad with a plurality of buttons, each button including first and second button contacts. A flexible printed circuit having opposite first and second ends is included, where the second end is connected to the keypad, and a plurality of spaced electrical traces extend longitudinally between the first and second ends of the flexible printed circuit. The electrical traces are aligned along a width of the flexible printed circuit and include a set of two or more button signal traces individually electrically coupled with a first button contact of a corresponding one of the plurality of buttons. A first diagnostic electrical trace and a second diagnostic electrical trace form a diagnostic circuit with one another.

A receiving unit is configured to receive the first end of the flexible printed circuit and includes a plurality of electrical contacts configured to electrically couple to the electrical traces along the width of the flexible printed circuit. The electrical contacts include one or more diagnostic electrical contacts configured to electrically couple to the diagnostic trace. A processor is electrically coupled to the one or more diagnostic electrical contacts of the receiving unit. The processor performs a diagnostic check of the diagnostic circuit to determine a connected state between the first end of the flexible printed circuit and the receiving unit or between the second end of the flexible printed circuit and the keypad, the connected state indicates whether or not a failure condition exists along a designated portion of the diagnostic circuit.

In certain embodiments, a ground voltage is introduced to the first diagnostic electrical trace and a power supply voltage is introduced to the second diagnostic electrical trace. The processor compares a voltage difference across the diagnostic circuit to determine if the connection state includes a failure condition between the receiving unit and the flexible printed circuit.

### BRIEF DESCRIPTION OF THE DRAWINGS

The following description and drawings set forth certain illustrative implementations of the disclosure in detail, which are indicative of several exemplary ways in which the principles of the disclosure may be carried out. The illustrated examples, however, are not exhaustive of the many possible embodiments of the disclosure. Other objects, advantages and novel features of the disclosure will be appreciated from the following detailed description of the disclosure when considered in conjunction with the drawings, in which:

FIG. 1 is a top plan view illustrating a connection detector assembly for detecting a connected state between a keypad and a receiving unit with a flexible printed circuit in accordance with one or more aspects of the present disclosure;

FIG. 2 is a partial top schematic view of the connection detector assembly of FIG. 1 illustrating a diagnostic circuit and an electrical connection between the flexible printed circuit, the keypad and a plurality of buttons located thereon;

FIGS. 3 and 4 are cross-sectional end views of the flexible printed circuit of FIG. 2 illustrating a plurality of electrical traces located thereon;

FIG. 5 is perspective view showing a portion of the flexible printed circuit of FIGS. 2, 3 and 4;

FIG. 6 is a schematic diagram illustrating an electrical circuit in the connection detector assembly of FIGS. 1 and 2 showing an embodiment of the diagnostic circuit configured to detect a connection state between the keypad and a processor;

FIG. 7 is a top plan view of the flexible printed circuit of FIG. 1 illustrating a partial schematic diagram of a diagnostic circuit of the flexible printed circuit in a connected state;

FIG. 8 is a top plan view of the flexible printed circuit of FIGS. 1 and 7 illustrating a partial schematic diagram of the diagnostic circuit of the flexible printed circuit in a partially disconnected state due to angular misalignment;

FIGS. 9 and 10 are top plan views of the flexible printed circuit of FIG. 1 illustrating an alternate embodiment of the diagnostic circuit having short electrical traces;

FIG. 11 is a schematic diagram illustrating the connection detector assembly of FIG. 1 including an alternate embodiment of the diagnostic circuit and the electrical connection between the flexible printed circuit, the keypad and a plurality of buttons located thereon;

FIG. 12 is a schematic plan view of the electrical circuit FIGS. 1 and 11 illustrating another embodiment of the diagnostic circuit configured to detect a connection state between the keypad and the processor; and

FIG. 13 is a schematic diagram illustrating the connection detector assembly of FIG. 1 including an alternate embodiment of the diagnostic circuit and the electrical connection between the flexible printed circuit, the keypad and a plurality of buttons located thereon.

### DETAILED DESCRIPTION

Referring now to the figures, several embodiments or implementations are hereinafter described in conjunction with the drawings, where like reference numerals are used to refer to like elements throughout, and where the various features are not necessarily drawn to scale. The present disclosure provides a connection detection assembly 10 that is configured to detect the integrity of a connection state between a peripheral electrical device and a processor or controller. The disclosed approaches may be advantageously employed to reduce the need for rigid structural elements and mechanical fasteners to provide a sufficient connection state. Additionally, the disclosed assemblies include a simple electrical structure that does not require specialized features such as a complex electrical connection and/or an advanced circuit configuration to adequately detect the integrity of the connection state.

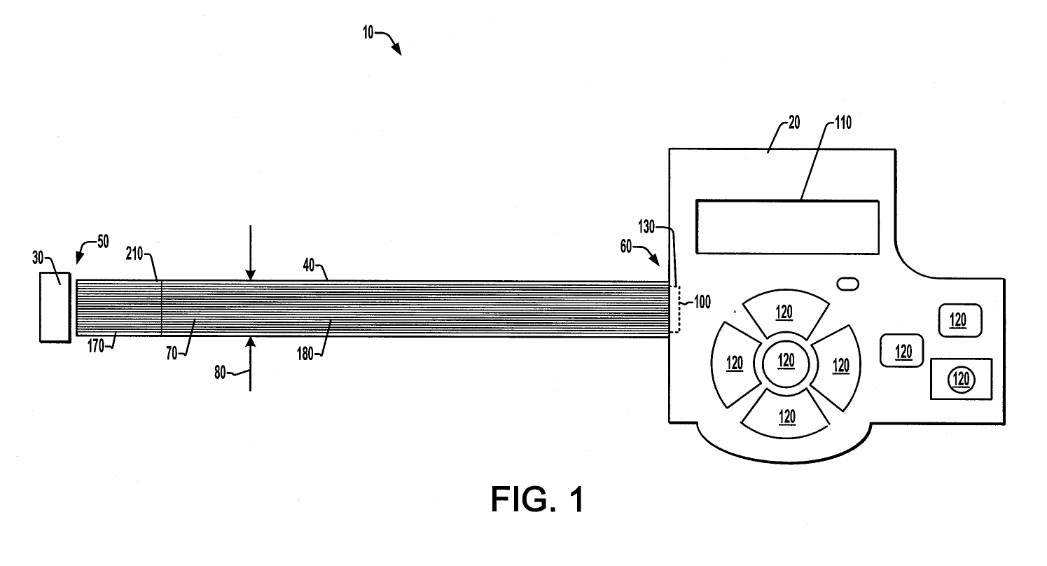

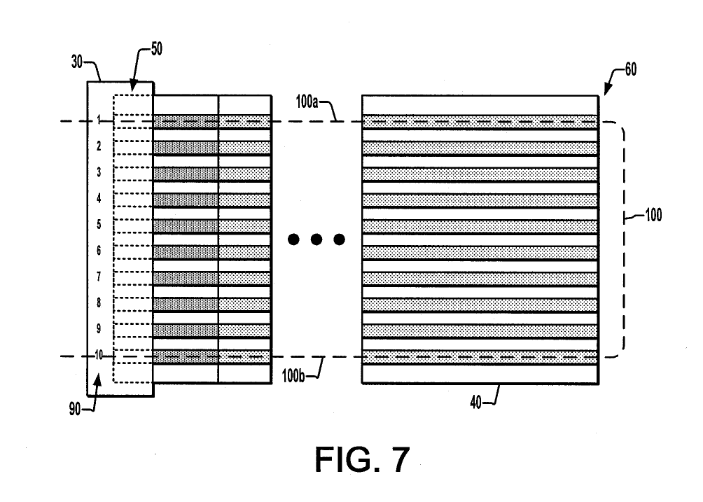

Referring initially to FIG. 1, an exemplary connection detection assembly 10 is illustrated, which may be advantageously employed to facilitate electrical communication between a peripheral electrical devise such as a keypad 20 and a receiving unit 30. The receiving unit 30 is preferably located on a printed circuit board (PCB) that can be within an electrical housing for an associated device such as a motor controller driver that is in operable communication with a processor 220 (FIG. 6). However, other embodiments are contemplated herein. The connection detection assembly 10 is employed for detecting a connected state between the keypad 20 and the processor 220.

The receiving unit 30 is configured to receive a portion of a flexible printed circuit 40. The flexible printed circuit 40 includes a first end 50 and an opposite second end 60 that is connected to the keypad 20. The first end 50 is operably connected to the receiving unit 30. A plurality of electrical traces 70 are laterally spaced from one another, and longitudinally extend between the first end 50 and the second end 60 of the flexible printed circuit 40. The plurality of electrical traces 70 are aligned along a width 80 of the flexible printed circuit 40 such that the flexible printed circuit 40 can maintain a slender and flexible profile in certain embodiments. The flexibility of the connection detection assembly 10 in certain embodiments facilitates a dependable electrical connection that is easily detachable and maintainable in an area with limited extra space.

In one embodiment, the keyboard 20 includes a display 110 for illustrating a variety of visual outputs and a plurality of individual buttons 120 that are configured to be pressed by a user to provide an input signal across the electrical button signal traces 70 of the flexible printed circuit 40. The buttons 120 electrically function as a common switch that completes a corresponding circuit when depressed.

The receiving unit 30 is configured to receive the first end 50 of the flexible printed circuit 40 and includes a plurality of electrical contacts 90 (see FIGS. 6-8 and 10) configured to electrically couple to the plurality of electrical traces 70 along the width 80 of the flexible printed circuit 40. The receiving unit 30 can be a zero insertion force (ZIF) connector assembly that includes a fastener for frictionally connecting the first end 50 of the flexible printed circuit 40 to the receiving unit 30 such that each of the plurality of electrical contacts 90 ideally are aligned with and contact the associated electrical trace 70.

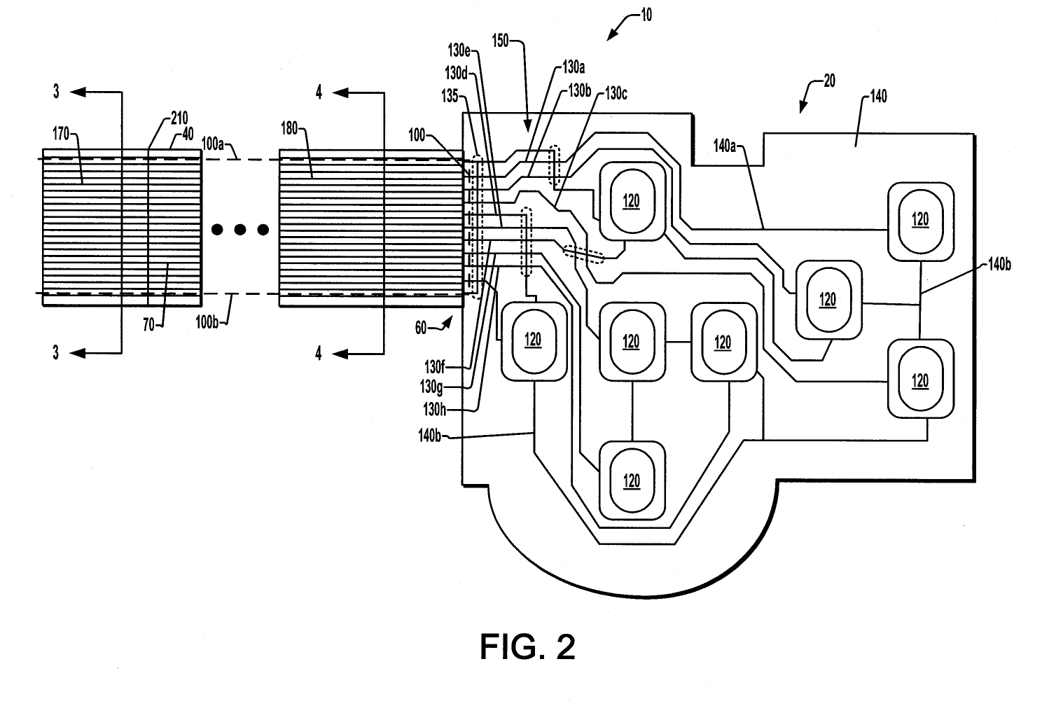

Turning to FIG. 2, a first diagnostic electrical trace 100a and a second diagnostic electrical trace 100b are adapted to form a diagnostic circuit 100 with one another. In this embodiment, the first and second diagnostic electrical traces 100a, 100b are electrically coupled to each other across the keypad 20. However, it is also contemplated that the diagnostic electrical traces 100a, 100b can be coupled across the flexible printed circuit 40 to complete the diagnostic circuit 100. As illustrated by FIGS. 1 and 2, the diagnostic circuit 100 is coupled across the keypad 20 along a bridge trace 135.

The keypad 20 includes a membrane 140 having a plurality of buttons 120 and interconnected circuitry 150 thereon. The plurality of electrical traces 70 extend from the flexible printed circuit 40 and into the membrane 140 in electrical alignment with the related circuitry 150. The circuitry 150 is configured to electrically connect the buttons 120 on the keypad 20 with the processor 220 (FIG. 6) through the flexible printed circuit 40. The keypad 20 can include any desired number of buttons 120 such that the number of buttons 120 coincides with the number of button signal traces 130 provided along the flexible printed circuit 40 and related circuitry 150. The flexible printed circuit 40 includes at least one set of additional traces 70 than the number of buttons 120 desired to electrically communicate with the processor 220 in this system. The additional traces comprise the diagnostic circuit 100. The keypad 20 can optionally contain a “stop” button that can provide a shutoff signal to the associated motor drive that is not communicated across the flexible printed circuit.

Each button 120 in the illustrated embodiment includes a first button contact 140a and a second button contact 140b. The button signal traces 130 are individually electrically coupled with the first button contact 140a of a corresponding one of the plurality of buttons 120. In the embodiment of FIG. 2, the keypad 20 includes eight (8) buttons 120 and therefore eight (8) button signal traces 130a, 130b, 130c, 130d, 130e, 130f, 130g and 130h are provided on the flexible printed circuit 40. The additional first and second diagnostic electrical traces 100a, 100b form the diagnostic circuit 100 with one another and are adapted in the illustrated embodiment to electrically couple to the second button contact 140b of each of the plurality of buttons 120.

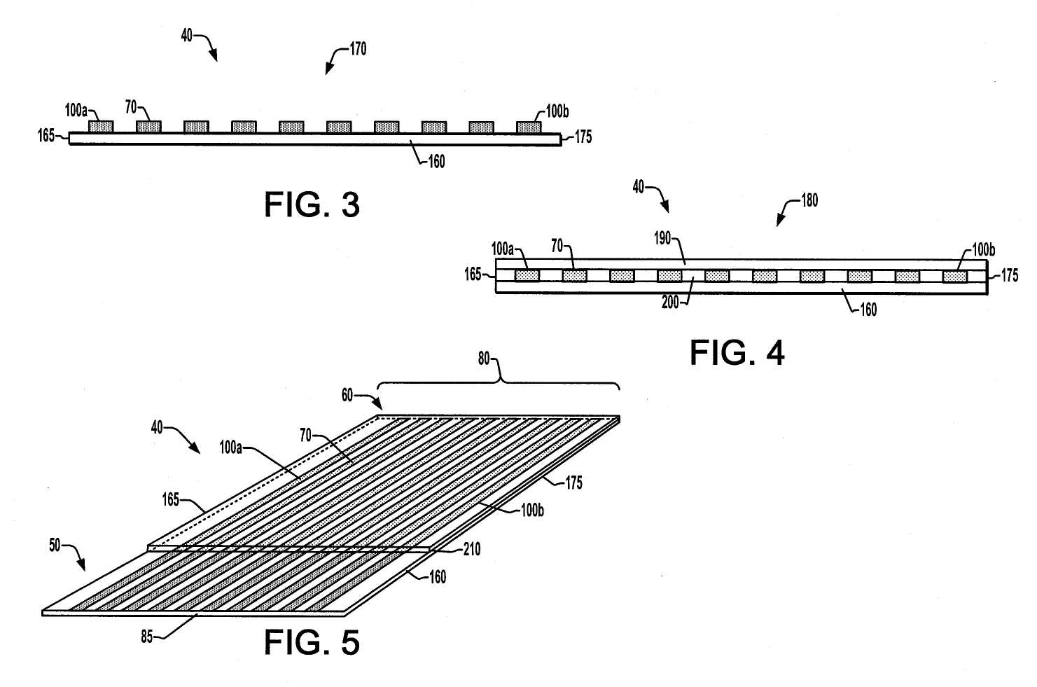

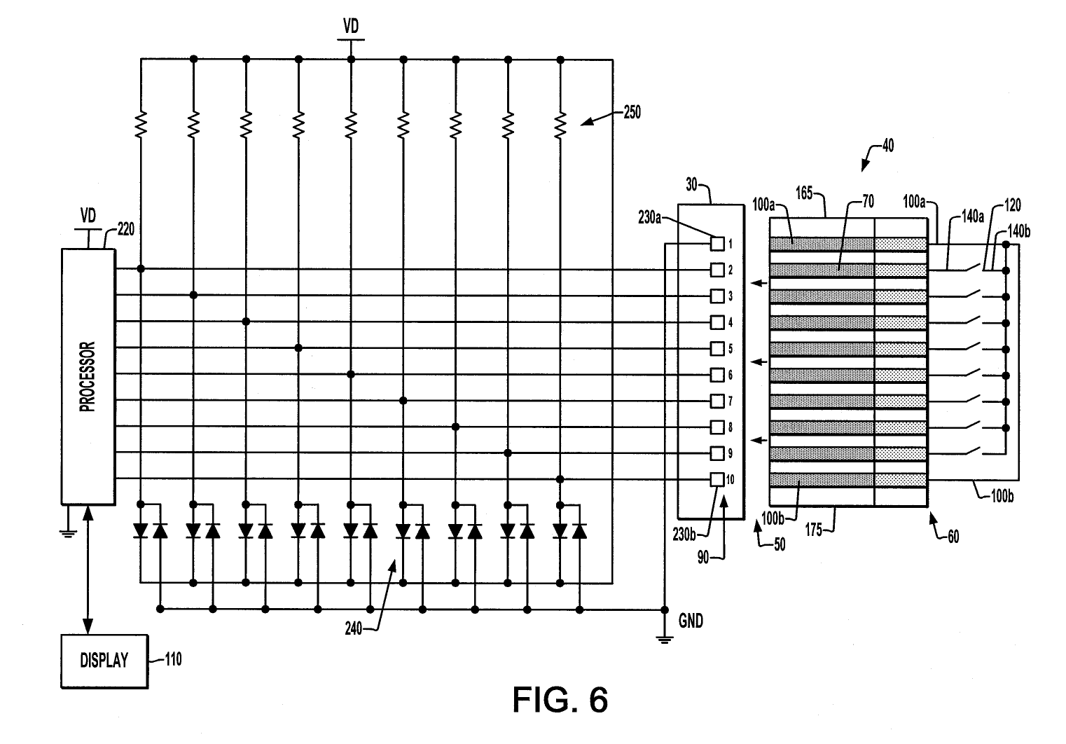

FIGS. 3-5 illustrate that the plurality of traces 70 can extend in certain embodiments along the flexible printed circuit 40 in a generally planar arrangement such that the plurality of electrical traces 70 are co-planar along the width 80 thereof. It is also contemplated that the plurality of traces 70 can include multiple rows that are stacked and separated from one another along the width 80 of the flexible printed circuit 40. The width 80 extends between a first longitudinal edge 165 and a laterally oppositely spaced second longitudinal edge 175. A front edge 85 extends along the first end 50 between the first longitudinal edge 165 and the second longitudinal edge 175. In the embodiment of FIG. 3, a cross-section of an exposed portion 170 of the electrical traces 70 opens the traces 70 to the environment and are indicated to rest along a surface of a first layer 160 of the flexible printed circuit 40. The plurality of electrical traces 70 near the first end 50 of the flexible printed circuit 40 are at least partially coated with a carbon material in certain embodiments. The first diagnostic electrical trace 100a can be positioned adjacent the first longitudinal edge 165 and the second diagnostic electrical trace 100b can be adjacent to the second longitudinal edge 175. In this embodiment, the first and second diagnostic electrical traces 100a, 100b are positioned along opposite sides of the flexible printed circuit 40. However, it is contemplated that the diagnostic electrical traces 100a, 100b can be located at alternate locations along the width of the flexible printed circuit 40.

In the embodiment of FIG. 4, a covered portion 180 of the electrical traces are shielded by a second layer 190 while including a filler material 200 between each trace 70 and along the first and second longitudinal edges 165, 175 of the flexible printed circuit 40. Optionally, the filler material 200 can also be provided along the electrical traces 70 in the exposed portion 170 (not shown). The first layer 160, second layer 190 and filler material 200 in certain embodiments are a flexible polymer coating for the electrical traces 70 although other materials can be used. The exposed portion 170 of the flexible printed circuit 40 is generally positioned towards the first end 50 and the covered portion 180 is positioned towards the second end 60. As illustrated by FIGS. 1, 2 and 5, the exposed portion and the covered portion are separated by line 210 along the flexible printed circuit 40 and line 210 can be located at any position thereon.

FIG. 6 schematically illustrates the processor 220 as it is electrically connected to the receiving unit 30 that can be electrically coupled to the flexible printed circuit 40 and the plurality of traces 70 thereon. Any form of electronic processing component 220 can be used, including without limitation microprocessors, microcontrollers, digital signal processors, programmable logic, dedicated logic circuits, etc., or combinations thereof. The receiving unit 30 includes a plurality of electrical contacts 90 such as pins that align with the plurality of traces 70 along the width 80 of the flexible printed circuit 40. The receiving unit 30 includes diagnostic electrical contacts 230a, 230b to align with the diagnostic traces 100a, 100b such that electrical contact 230a is electrically coupled with electrical contact 230b when the flexible printed circuit 40 is coupled to the receiving unit 30. Additionally, FIG. 6 illustrates the flexible printed circuit 40 as the front edge 85 is being inserted into the receiving unit 30 to electrically connect the electrical traces 70 with the electrical contacts 90.

Also provided in the illustrated embodiment are plurality of blocking diodes 240 that are electrically connected to the receiving unit 30 to provide protection to the connection detector assembly 10 from electrostatic discharge, although the diodes 240 can be omitted in certain embodiments. Pull-up resistors 250 are also provided to assist with signal differentiation by the processor 220 between a ground voltage GND and a supply voltage VD.

The processor 220 in certain embodiments is configured to perform a diagnostic check of the diagnostic circuit 100 to determine the integrity of a connected state between the first end 50 of the flexible printed circuit 40 and the receiving unit 30 or between the second end 60 of the flexible printed circuit 40 and the keypad 20. The processor performs the diagnostic check on the connected state between the plurality of traces 70 along the width 80 of the first end 50 of the flexible printed circuit 40 and the electrical contacts 90 of the receiving unit 30. The processor 220 can be configured to perform the diagnostic check at predetermined intervals (e.g., once a hour or day) or at any other time desired by the user, and the diagnostic check may be performed in response to a user signal or message in certain embodiments, thereby facilitating quick troubleshooting. The processor 220 in certain embodiments, moreover, can detect connection failure upon a “power up” stage of the associated motor drive and can send a report to a third party if a fault is detected. The connected state of the flexible printed circuit 40 indicates whether or not a failure condition exists along the diagnostic circuit 100. As the first end 50 of the flexible printed circuit 40 is inserted into the receiving unit 30, a ground voltage GND is electrically coupled with the first diagnostic electrical trace 100a and a power supply voltage VD is electrically coupled via the corresponding pull-up resistor 250 to the second diagnostic electrical trace 100b. When the diagnostic check is performed, electrical contact 230a is pulled low to the ground voltage GND and electrical contact 230b is pulled high via the pull-up resistor 250 to the power supply voltage VD. The processor 220 monitors the voltage level of the diagnostic circuit 100 at the electrical contact 230b to determine if the connection state includes a failure condition between the receiving unit 30 and the flexible printed circuit 40.

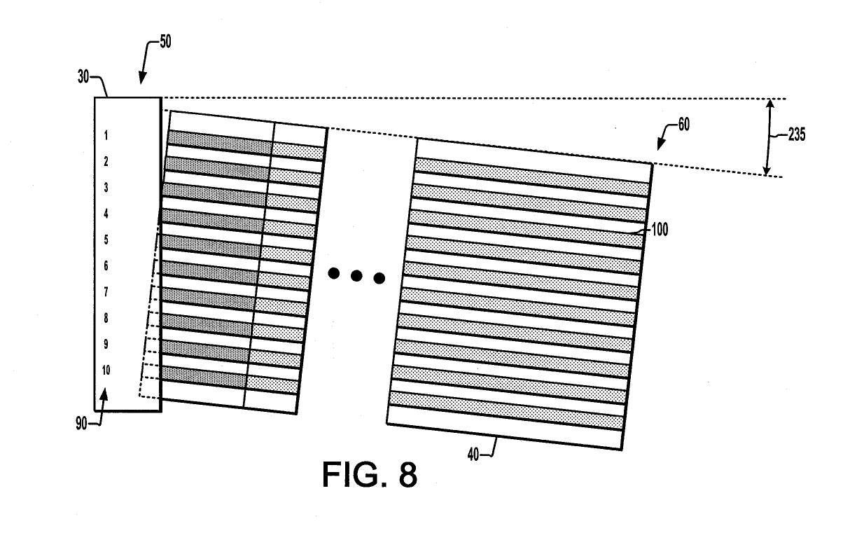

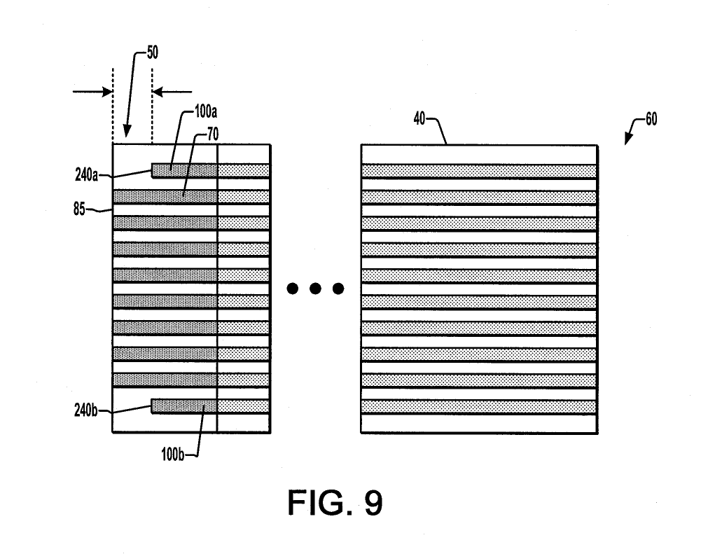

When the processor 220 identifies voltage at electrical contact 230b to be low, then the connected state between the flexible printed circuit 40 and the receiving unit 30 is in a normal condition and electrical connection is sufficient (such as in FIG. 7). When the processor 220 identifies the voltage across the electrical contact 230b to be high, then the connected state is in a failure condition and the electrical connection is not sufficient. A failure condition could indicate that the flexible printed circuit 40 is not fully electrically connected to the receiving unit 30 or is merely connected at an angle (such as in FIG. 8). Also, the failure condition could indicate the existence of material degradation or failure of the flexible printed circuit 40 and diagnostic circuit 100 thereof.

FIG. 7 illustrates one embodiment of the present system wherein the flexible printed circuit 40 is electrically coupled to the receiving unit 30. The flexible printed circuit 40 is inserted into the receiving unit 30 such that the plurality of electrical contacts 90 are aligned with and in contact with the plurality of electrical traces 70. This configuration allows the diagnostic electrical traces 100a, 100b to form the diagnostic circuit 100 such that as the processor conducts the diagnostic check, the connection status is considered normal.

FIG. 8 illustrates the flexible printed circuit 40 that has been at least partially separated from the receiving unit 30. The front edge 85 is partially inserted in the receiving unit 30 such that the first diagnostic trace 100a is not in electronic communication with the first electric contact 230a while the second diagnostic trace 100b is in electronic communication with the second electric contact 230b. This happens when the flexible printed circuit 40 partially disengages from the receiving unit 30 and is slanted away from proper alignment by at least a minimum angle 235. Here, at least one of the button signal traces 130a-130h of the plurality of electrical traces 70 are not electrically communicating with the respective electric contacts 90 of the receiving unit 30 Therefore, the keypad 20 cannot properly transmit one or more corresponding input signals to the processor 220. Once this condition is identified by the processor 220, the processor 220 transmits a signal to the display 110 to indicate the existence of a failed connection, and may be programmed to take one or more other actions in response to this detected condition.

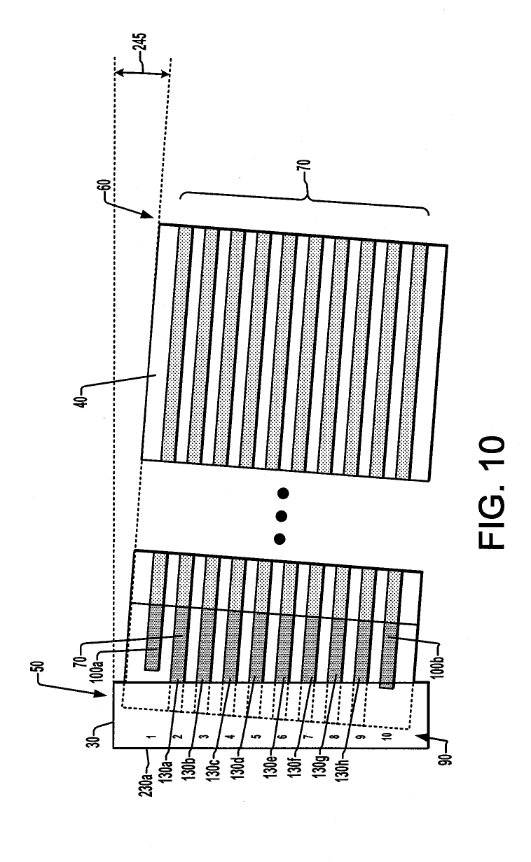

FIG. 9 illustrates another embodiment of the connection detector assembly 10 wherein the first and second diagnostic traces 100a, 100b of the flexible printed circuit 40 have a similar first length such that edges 240a, 240b of the diagnostic traces 100a, 100b are spaced from the first edge 85 of the flexible printed circuit 40. The remainder of the plurality of electrical traces 70 include a similar second length such that the second length is greater than the first length of diagnostic traces 100a, 100b. The remainder of the plurality of electrical traces 70 can extend up to the first edge 85 of the flexible printed circuit 40. The difference in length allows the assembly 10 to properly identify when the flexible printed circuit 40 is partially slanted away from proper alignment while the plurality of electrical button traces 130a-130h remain in electronic communication with the respective electrical contacts 90. In this embodiment, as shown in FIG. 10, the processor 220 can identify an improper connection due to a partially slanted flexible printed circuit at a second minimum angle 245 which is less than the first minimum angle 235 of FIG. 8. Here, the diagnostic circuit 100 has been interrupted as the first diagnostic trace 100a is separated from electrical contact 230a while each remaining electrical traces 70 are in electrical communication with the receiving unit 30. By this embodiment, therefore, the system can detect misalignment prior to disruption in actual switch connections, thereby facilitating proactive maintenance.

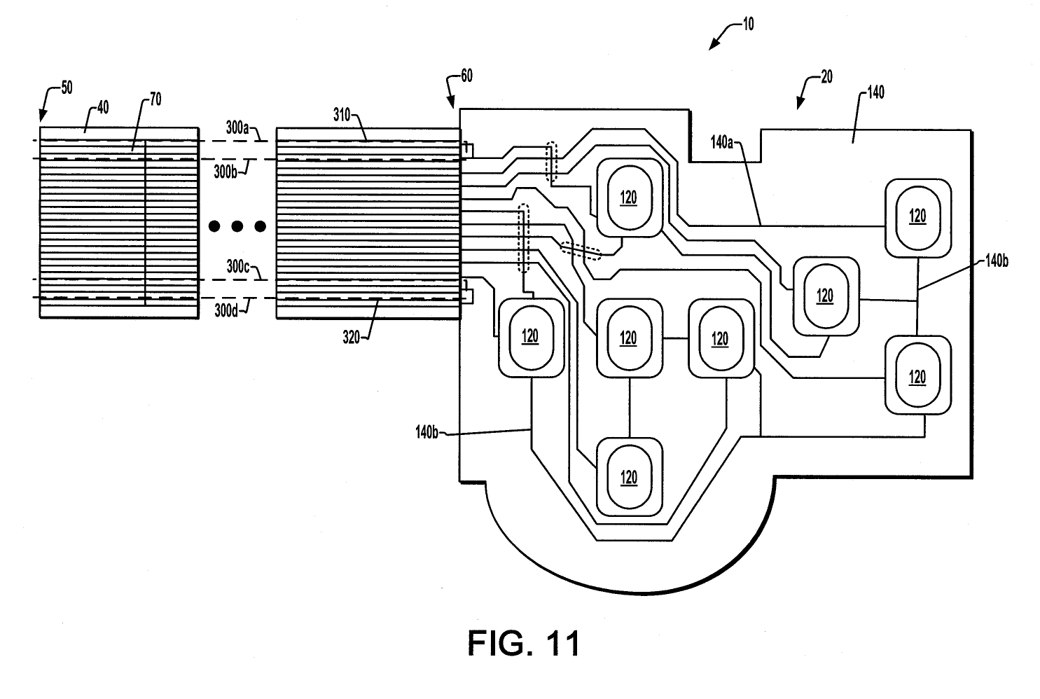

Turning to FIG. 11, wherein similar reference numbers represent similar features, a separate embodiment of the flexible printed circuit 40 of the connection detector assembly 10 includes a third diagnostic electrical trace 300c and a fourth diagnostic electrical trace 300d that extend between the first end 50 and the second end 60 of the flexible printed circuit 40. The third and fourth diagnostic electrical traces 300c, 300d are electrically coupled to each other across either the keypad 20 or along the flexible printed circuit 40 to complete another diagnostic circuit 320 that is spaced from the diagnostic circuit 310. The first and second diagnostic electrical traces 300a, 300b are also electrically coupled to each other to complete diagnostic circuit 310 across the keypad 20. The processor is configured to perform the diagnostic check on the connected state between the plurality of traces 70 along the width 80 of the first end 50 of the flexible circuit and the electrical contacts 90 of the receiving unit 30.

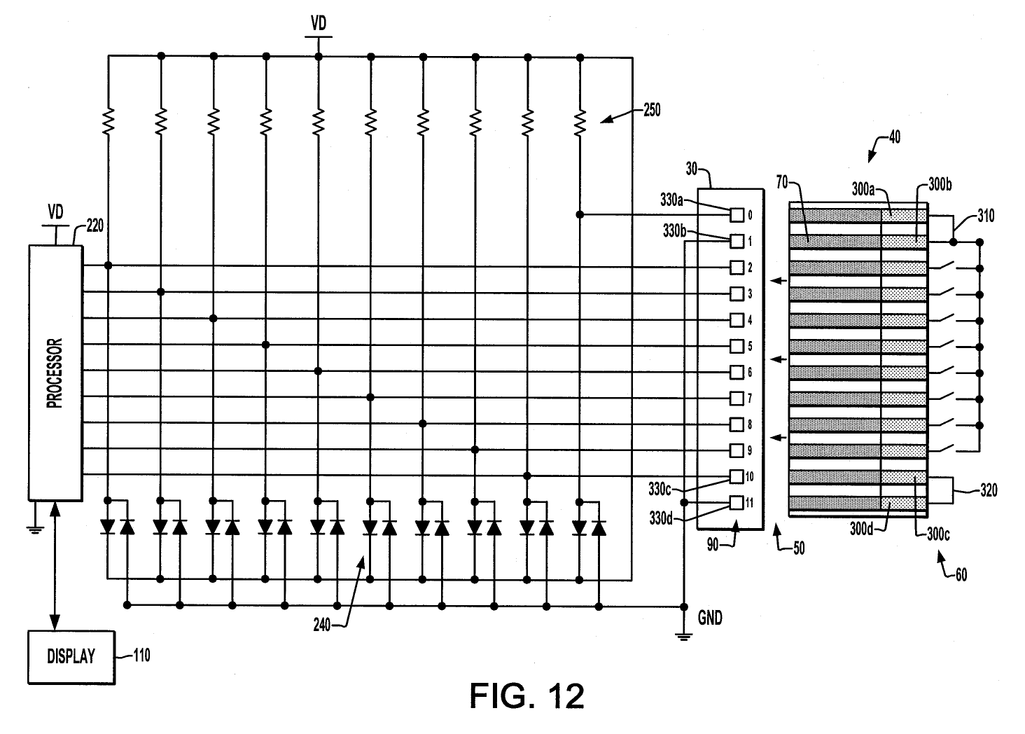

In this embodiment, as illustrated by the schematics of FIG. 12, the power supply voltage VD is electrically coupled with the first and third diagnostic electrical traces 300a, 300c and the ground voltage GND is electrically coupled to the second and fourth diagnostic electrical traces 300b, 300d. The processor 220 compares the voltage difference across the diagnostic circuits 310 and 320 to determine if the connection state includes a failure condition between the receiving unit 30 and the flexible printed circuit 40.

Diagnostic circuit 310 extends along the first longitudinal edge 165 while the diagnostic circuit 320 extends along the second longitudinal edge 175. The first diagnostic electrical trace 300a and a second diagnostic electrical trace 300b are positioned adjacent the first longitudinal edge 165. The third electrical trace 300c and a fourth electrical trace 300d are positioned adjacent the second longitudinal edge 175. In this configuration, each diagnostic circuit 310, 320 on opposite sides along the width 80 of the flexible printed circuit 40 to assist with the diagnostic check. However, it is contemplated that the diagnostic electrical circuits 310 and 320 can be located at any alternate location along the width 80 of the flexible printed circuit 40.

The receiving unit 30 of this configuration includes diagnostic electrical contacts 330a, 330b, 330c and 330d to align with the diagnostic traces 300a-300d such that electrical contact 330a is electrically coupled with electrical contact 330b and electrical contact 330c is electrically coupled with electrical contact 330d when the flexible printed circuit 40 is coupled to the receiving unit 30.

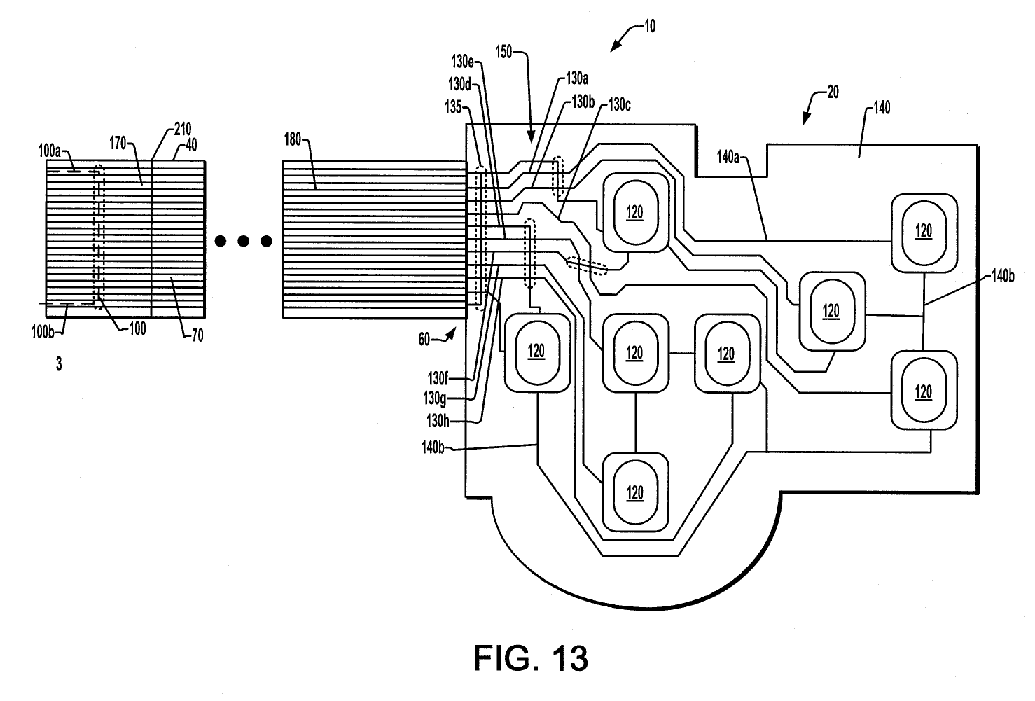

FIG. 13 illustrates an additional embodiment of the connection detector assembly 10. The diagnostic traces 100a, 100b are configured such that completion of the diagnostic circuit 100 is along the flexible printed circuit 40. The first and second diagnostic traces 100a, 100b are electrically connected over the button signal traces 130a-130h on the flexible printed circuit 40 by a bridge path 340. This embodiment includes a diagnostic circuit 100 having shortened diagnostic traces 100a, 100b which reduces the amount of electromagnetic interference and improves the electromagnetic compatibility of the system. The presence of electrical noise generated either internally or externally by other systems has a reduced effect on the diagnostic circuit 100 thereby increasing the reliability of the assembly.

The above examples are merely illustrative of several possible embodiments of various aspects of the present disclosure, where equivalent alterations and/or modifications will occur to others skilled in the art upon reading and understanding this specification and the annexed drawings. In particular, although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A connection detector assembly for detecting a connected state between a keypad and a processor, comprising:
a keypad including a plurality of buttons, the individual buttons including first and second button contacts;
a flexible printed circuit having a first end, an opposite second end connected to the keypad, a plurality of electrical traces spaced from one another and longitudinally extending between the first end and the second end of the flexible printed circuit, the plurality of electrical traces being aligned along a width of the flexible printed circuit and including a set of two or more button signal traces individually electrically coupled with a first button contact of a corresponding one of the plurality of buttons, and first and second diagnostic electrical traces forming a diagnostic circuit with one another;
a receiving unit configured to receive the first end of the flexible printed circuit and having a plurality of electrical contacts configured to electrically couple to the plurality of electrical traces along the width of the flexible printed circuit, the plurality of electrical contacts including one or more diagnostic electrical contacts configured to electrically couple to the at least one diagnostic trace; and
a processor electrically coupled to the one or more diagnostic electrical contacts of the receiving unit, the processor being configured to perform a diagnostic check of the diagnostic circuit to determine a connected state between the first end of the flexible printed circuit and the receiving unit or between the second end of the flexible printed circuit and the keypad, the connected state indicating whether or not a failure condition exists along a designated portion of the diagnostic circuit.

2. The connection detector assembly of claim 1, wherein the flexible printed circuit includes a generally planar arrangement and the plurality of electrical traces are co-planar along the width of the flexible printed circuit.

3. The connection detector assembly of claim 1, wherein the first and second diagnostic electrical traces are electrically coupled to each other across one of the keypad and the flexible printed circuit to complete the diagnostic circuit.

4. The connection detector assembly of claim 3, wherein the diagnostic circuit further comprises:
a ground voltage electrically coupled with the first diagnostic electrical trace and a power supply voltage electrically coupled to the second diagnostic electrical trace,
wherein the processor compares a voltage difference across the diagnostic circuit to determine if the connection state includes a failure condition between the receiving unit and the flexible printed circuit.

5. The connection detector assembly of claim 3, wherein the first and second diagnostic electrical traces are electrically coupled to each other across the keypad such that the processor performs the diagnostic check on the connected state between the plurality of traces along the width of the first end of the flexible printed circuit and the electrical contacts of the receiving unit.

6. The connection detector assembly of claim 3, wherein the diagnostic circuit further comprises:
a third diagnostic electrical trace and a fourth diagnostic electrical trace extending between the first end and the second end of the flexible printed circuit such that the third and fourth diagnostic electrical traces are electrically coupled to each other across one of the keypad and the flexible printed circuit to complete the diagnostic circuit.

7. The connection detector assembly of claim 6, wherein the first and second diagnostic electrical traces are electrically coupled to each other across the keypad and the third and fourth diagnostic electrical traces are electrically coupled to each other across the keypad such that the processor performs the diagnostic check on the connected state between the plurality of traces along the width of the first end of the flexible circuit and the electrical contacts of the receiving unit.

8. The connection detector assembly of claim 6, wherein the diagnostic circuit further comprises:
a ground voltage electrically coupled with the first and third diagnostic electrical traces and a power supply voltage being electrically coupled to the second and fourth diagnostic electrical traces,
wherein the processor compares a voltage difference across the diagnostic circuit to determine if the connection state includes a failure condition between the receiving unit and the flexible printed circuit.

9. The connection detector assembly of claim 1, wherein the flexible printed circuit includes a generally planar arrangement such that the width of the flexible printed circuit extends between a first longitudinal edge and an oppositely spaced second longitudinal edge.

10. The connection detector assembly of claim 9, wherein the first diagnostic electrical trace is positioned adjacent the first longitudinal edge and the second diagnostic electrical trace is positioned adjacent the second longitudinal edge, the first and second diagnostic electrical traces are electrically coupled to each other across one of the flexible printed circuit and the receiving unit.

11. The connection detector assembly of claim 10, wherein the first and second diagnostic electrical traces of the plurality of electrical traces have a similar first length and the remainder of the plurality of electrical traces have a similar second length such that the first length is less than the second length.

12. The connection detector assembly of claim 10, wherein the first and second diagnostic electrical traces are electrically coupled to each other across the keypad such that the processor performs the diagnostic check on the connected state between the plurality of traces along the width of the first end of the flexible circuit and the electrical contacts of the receiving unit.

13. The connection detector assembly of claim 10, wherein the diagnostic circuit further comprises:
a ground voltage electrically coupled with the first diagnostic electrical trace and a power supply voltage being electrically coupled to the second diagnostic electrical trace,
wherein the processor compares a voltage difference across the diagnostic circuit to determine if the connection state includes a failure condition between the receiving unit and the flexible printed circuit.

14. The connection detector assembly of claim 9, wherein the diagnostic circuit further comprises:
a first diagnostic electrical trace and a second diagnostic electrical trace positioned adjacent the first longitudinal edge, the first and second electrical traces are electrically coupled across one of the keypad and the receiving unit; and
a third electrical trace and a fourth electrical trace positioned adjacent the second longitudinal edge, the third and fourth electrical traces are electrically coupled across one of the keypad and the receiving unit,
wherein the processor is adapted to perform the diagnostic check on the connected state between the first end of the flexible printed circuit and the receiving unit or the second end of the flexible printed circuit and the keypad.

15. The connection detector assembly of claim 14, wherein the first and second electrical traces are electrically coupled to each other across the keypad and the third and fourth electrical traces are electrically coupled to each other across the keypad such that the processor performs the diagnostic check on the connected state between the plurality of traces along the width of the first end of the flexible circuit and the electrical contacts of the receiving unit.

16. The connection detector assembly of claim 14, wherein the diagnostic circuit further comprises:
a power supply voltage electrically coupled with the first and third electrical traces and a ground voltage being electrically coupled to the second and fourth electrical traces,
wherein the processor compares a voltage difference across the diagnostic circuit to determine if the connection state includes a failure condition between the receiving unit and the flexible printed circuit.

17. The connection detector assembly of claim 1, wherein the receiving unit is a zero insertion force connector assembly that includes a fastener for frictionally connecting the first end of the flexible printed circuit to the receiving unit such that each electrical contact of the receiving unit is aligned with and contacts an associated electrical trace.

18. The connection detector assembly of claim 1, wherein flexible printed circuit includes a polymer coating between the first end and the second end.

19. The connection detector assembly of claim 1, wherein the plurality of electrical traces at the first end of the flexible printed circuit are at least partially coated with a carbon material.

20. A keypad assembly, comprising:
a keypad including a plurality of buttons, the individual buttons including first and second button contacts; and
a flexible printed circuit having a first end, an opposite second end connected to the keypad, a plurality of electrical traces spaced from one another and longitudinally extending between the first end and the second end of the flexible printed circuit, the plurality of electrical traces being aligned along a width of the flexible printed circuit and including a set of two or more button signal traces individually electrically coupled with a first button contact of a corresponding one of the plurality of buttons, and first and second diagnostic electrical traces forming a diagnostic circuit with one another.
